(19) United States
(12) Patent Application Publication
(10) Pub. No.: US 2014/0097212 A1
(43) Pub. Date: Apr. 10, 2014

(54) DRYWALL COMPOUND DISPENSING SYSTEM

(71) Applicant: Jose R. Pineda, West Palm Beach, FL (US)

(72) Inventor: Jose R. Pineda, West Palm Beach, FL (US)

(21) Appl. No.: 14/046,378

(22) Filed: Oct. 4, 2013

Related U.S. Application Data
(60) Provisional application No. 61/709,782, filed on Oct. 4, 2012.

(51) Int. Cl. B65D 5/72

(52) U.S. Cl. CPC B05C 17/00506
USPC 222/567

(57) ABSTRACT

The present invention relates to tools for finishing drywall. More specifically, the present invention is a system for use in dispensing drywall joint compound from a container. The system comprises a base member that is semi-permanently securable to a manual joint compound pump and a plurality of attachments that are removably securable to the base member to provide various manners of dispensing joint compound. One end of the base member is constructed to function as a first portion of a quick connector. Each of the plurality of attachments is provided with a second portion of the quick connector. The cooperation between the first and second portions of the quick connector allow a technician to quickly change tools by hand to those that better suit his needs for improved efficiency.

### RELATED APPLICATION

In accordance with 37 C.F.R 1.76, a claim of priority is included in an Application Data Sheet filed concurrently herewith. Accordingly, the present invention claims priority under 35 U.S.C. §119(e) to U.S. Provisional Application 61/709,782 entitled “DRYWALL COMPOUND DISPENSING SYSTEM” filed on Oct. 4, 2012. The contents of each of the above referenced applications are herein incorporated by reference in its entirety.

### FIELD OF THE INVENTION

This invention relates to drywall compound dispensing devices, and more particularly to a dispensing system having quick change dispensing tools securable to a drywall compound pump.

### BACKGROUND OF THE INVENTION

Drywall (also known as plasterboard, wallboard, or gypsum board), a panel product made of gypsum plaster pressed between two thick sheets of paper and/or polymer is used to construct interior walls or ceilings of residential and commercial buildings. Drywall panels normally range in thickness from ¼″ to ¾″. Application of different thicknesses or multiple layers can provide improved fire resistance qualities. The panels are attached to wood or metal studs by means of drywall fasteners, the most common known as drywall screws. Drywall joint compound is a white substance similar to plaster which is used to seal the joints between the panels, cover nail screw heads, and generally form a smooth or flat surface to provide a uniform texture over which paint or wall paper can be applied. Workers who specialize in drywall installation use a variety of specialized tools designed to increase their productivity. A bazooka automatic taper is one such tool that is specifically designed for dispensing drywall joint compound along with tape to cover seams and corners of freshly installed drywall.

Because joint compound applicators such as bazookas are difficult to fill, specialized tools have been developed for making the filling operation simpler for the technician. One of the more commonly used systems includes a manually-operable pump, known as a Drywall Mud Pump manufactured by Drywall Master of Forest Park, Ill. The manually operated pump has a bottom portion which is inserted into an open five gallon container or pail holding joint compound. The top end of the pump includes a hand-operable pump handle and a discharge port for attachment to a gooseneck tube. Typically, a gooseneck attachment tube is connected to the pump to allow the drywall mud to be pumped into a tool such as the bazooka. The gooseneck tube is generally J-shaped and includes an upper end and lower end portion. The upper end of the gooseneck tube is directly connected to the top end discharge port of the pump with bolts or screws, and an O-ring sealing element is disposed between the gooseneck and the pump. The lower end portion of the gooseneck includes an outlet which fits into a portion of the bazooka automatic taping machine. In operation, the bazooka automatic taping machine is placed into the gooseneck and the pump handle is manually operated to pump the joint compound from the open top container though the pump, through the gooseneck tube, and into the bazooka. One downside to this construction relates to the requirement of two people to complete the filling operation. The bazooka is a large tool, typically five feet long, requiring one person to hold the device in contact with the gooseneck while a second person operates the pump. This shortcoming is exacerbated when the five gallon pail gets low on joint compound, requiring the person pumping to stabilize the pail to pump the viscous joint compound.

Another shortcoming relates to the need to fill containers other than the bazooka to complete a job such as finishing flat boxes. The prior art goosenecks are one piece and secured to the pump with fasteners. In order to fill the boxes with joint compound, the gooseneck tube must be detached from the discharge port on the mud pump. Thereafter, a nozzle is attached to the discharge pump to facilitate filling of the flat box. A problem encountered with the direct connection of the gooseneck to the mud pump is the continual detachment and reattachment thereof which leads to wasted time, frustration to a user, and wear on the devices. The user must have tools readily available to unscrew the bolts or screws on the upper portion of the gooseneck from the discharge port on the mud pump. The different materials used for the fasteners and the pump, e.g. steel and cast aluminum, in combination with the joint compound often results in galvanic reaction and causes the bolts to seize. The soft nature of the cast aluminum often results in the threads pulling out of the pump when the fasteners are removed. Repairs may be completed in some cases; however, they are costly and time consuming, resulting in downtime and added expense.

Thus, what is lacking in the art is a system for quickly and easily attaching and changing dispensing attachments to a drywall compound pump. The system should include a base portion that remains secured to the mud pump. The base portion should be constructed and arranged to cooperate with a plurality of attachments without the necessity for tools. The attachments should be easily interchangeable for cooperation with a variety of boxes, bazookas, automatic tapers and the like.

### SUMMARY OF THE INVENTION

The present invention relates to tools for finishing drywall. More specifically, the present invention is a system for use in dispensing drywall joint compound from a pail or container. The system comprises a base member that is permanently or semi-permanently securable to a manual joint compound pump and a plurality of attachments that are removably securable to the base member to provide various manners of dispensing joint compound. One end of the base member is constructed to function as a first portion of a quick connector. The plurality of attachments is provided with each attachment including the second portion of the quick connector. The cooperation between the first and second portions of the quick connector allow a technician to quickly change tools by hand to those that better suit his needs for improved efficiency. In a preferred embodiment, the base member is supplied with a gooseneck tool for filling bazooka automatic tape machines and a dual nozzle for filling various types of finishing boxes. The gooseneck attachment may be constructed and arranged to include tool holders which keep all of the attachments in a single place. In an additional embodiment, the tools may all be secured together with a tether. This construction eliminates the need to locate tools and attachments to complete a drywall finishing job; greatly improving efficiency and lowering cost of drywall finishing.

Accordingly, it is an objective of the present invention to provide a drywall compound dispensing system.

It is a further objective of the present invention to provide a drywall compound dispensing system that is constructed and arranged to cooperate with a hand operated drywall pump and includes a quick change tool arrangement which allows a user to quickly change dispensing tools.

It is another objective of the present invention to provide a drywall compound dispensing system wherein the quick change tool arrangement includes interlocking male and female components releasable and engagable by hand.

It is yet another objective of the present invention to provide a drywall compound dispensing system that includes a gooseneck attachment and a box filling attachment.

It is still yet another objective of the present invention to provide a drywall compound dispensing system that includes a dual nozzle for quicker and easier filling of a finishing box.

Yet another objective of the present invention is to provide a support bracket on the gooseneck attachment for supporting a bazooka automatic taper when the bazooka is attached to the outlet of the gooseneck.

It is a still further objective of the present invention to provide a gooseneck attachment containing a base plate for support and stability of the gooseneck as well as the pump during operation.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a perspective view of a prior art manual drywall compound pump and gooseneck filler;

FIG. 2 is a top perspective view of the first portion of the quick connector of the present invention;

FIG. 3 is a rear view of the first portion of the quick connector of FIG. 2;

FIG. 4 is a perspective view of one embodiment of the gooseneck attachment in accordance with the present invention;

FIG. 5 is a partial top perspective view of one embodiment of the gooseneck attachment secured to a drywall mud pump in accordance with the instant invention;

FIG. 6 is a top perspective view of the first portion of the quick connector of the present invention; and

FIG. 7 is a rear view of the first portion of the quick connector of FIG. 6.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

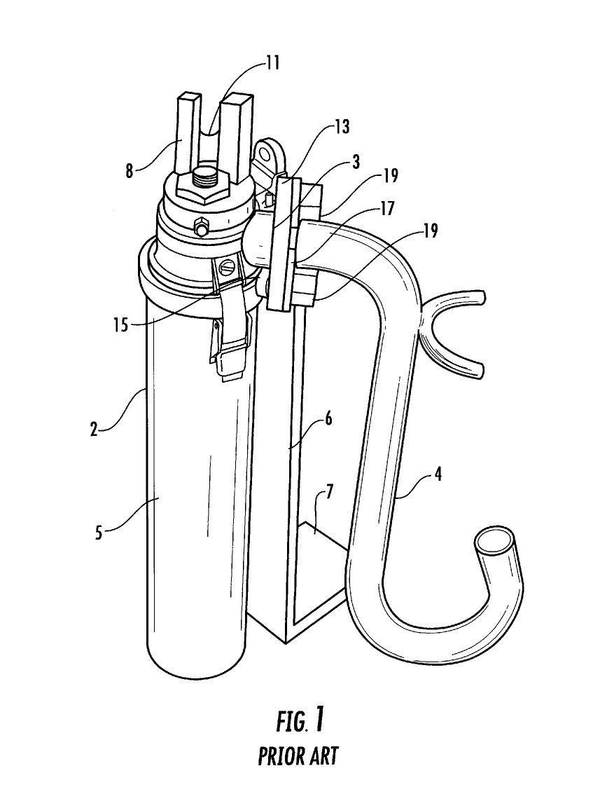

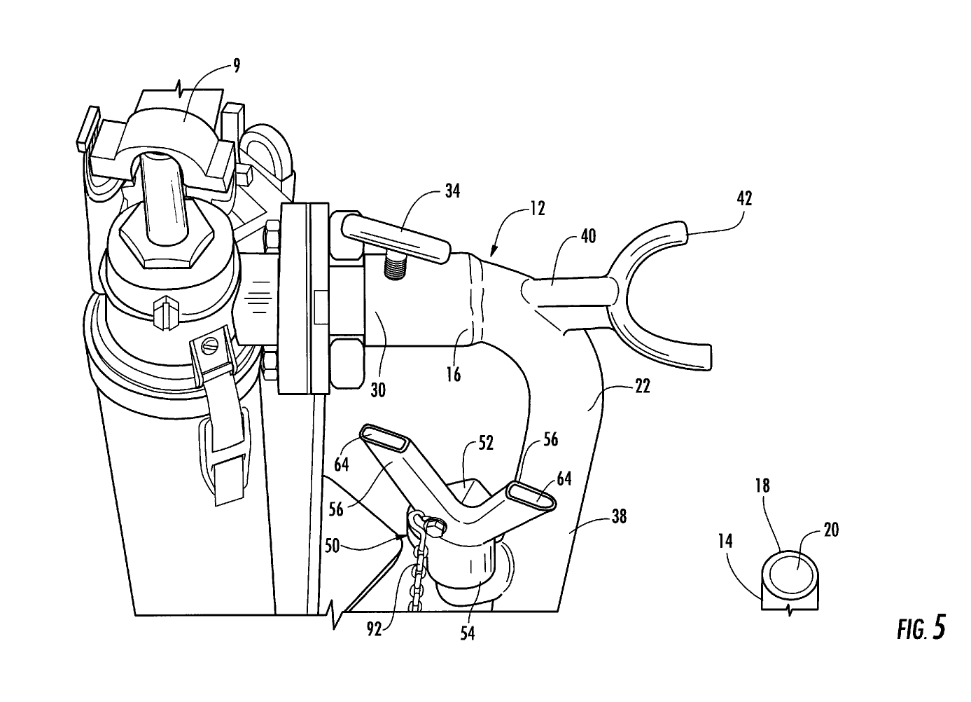

Referring to FIG. 1, a state of the art manually operated drywall compound or mud pump 2 is illustrated with a prior art gooseneck attachment. The drywall compound pump 2 includes a bottom portion 5 that is constructed for insertion into a five gallon pail of drywall joint compound (not shown) while stabilizing leg 6 extends down the outside wall of the pail so that the foot pad 7 rests on a ground surface. The top portion of the drywall compound pump 2 includes a hand-operable lever (not shown) connected through a pivot 9 (FIG. 5) to a pump rod 11. The bottom portion of the pump rod 11 includes seals, valves and the like to cause the pump rod to pull drywall compound from the pail and force it through a discharge port 3. The discharge port 3 includes an integrally formed flange 13 having threaded apertures 15 for securing dispensing tools to the discharge port 3. FIG. 1 illustrates a gooseneck tube 4 secured to the pump assembly for filling a bazooka automatic taping machine. The gooseneck tube 4 includes a connection flange 17 welded to an upper end portion of the gooseneck tube. The lower end portion of the gooseneck tube 4 includes an outlet for attachment to a drywall applicator. The connection flange 17 is directly connected to the discharge port 3 of the pump 2 with threaded fasteners 19. As shown, the fasteners 19 are typically constructed from a steel material, while the gooseneck tube and the pump are constructed from cast aluminum. Because the connection is pressurized during dispensing of the drywall compound, the compound often gets between the fastener and the pump causing a galvanic reaction therebetween. The galvanic reaction often causes the threads within the pump flange 13 to pull out with the fasteners, requiring replacement before the pump can be used again.

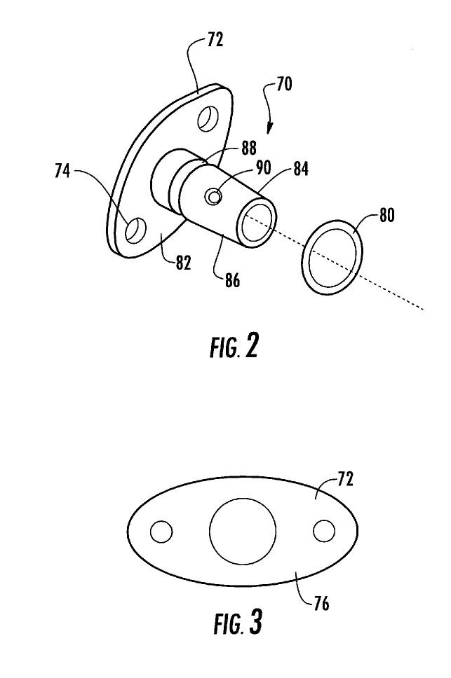

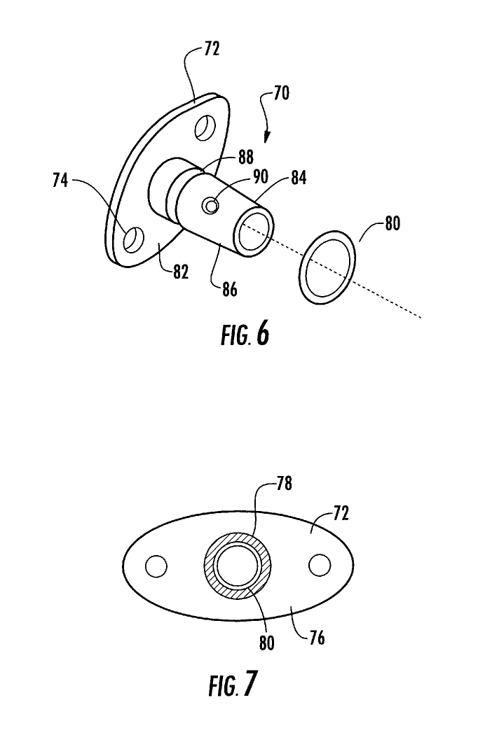

Referring to FIGS. 2-7, various figures representing one embodiment of the drywall compound dispensing system are illustrated. The drywall dispensing system generally includes a base member 70 and a plurality of drywall compound dispensing nozzles. In a particularly preferred embodiment, the drywall compound dispensing system includes a base member 70, a gooseneck tip 10 and a finishing box tip 50. The base member 70 is generally constructed and arranged to be secured to the drywall compound pump in a permanent or semi-permanent manner. As shown in FIGS. 2-3, the base member includes a connection flange 72 sized and shaped to cooperate with the discharge port flange 13 and includes a pair of apertures 74 sized and placed to align with the threaded or through apertures provided on the discharge flange 13. A front side 82 of the connection flange 72 includes an outwardly extending first portion 84 of a quick connector. The first portion 84 of the quick connector is constructed and arranged to cooperate with a second portion 30 of a quick connector, secured to the tips, to allow quick connection between the tips and the pump without the necessity of tools. In one embodiment, the first portion of the quick connector includes a tube portion 86. The tube portion includes an O-ring groove 88 and a lock indention 90. The outside diameter of the tube portion 86 is sized to fit inside of a second quick connector portion 16 in a manner that substantially prevents drywall compound from seeping between the two components.

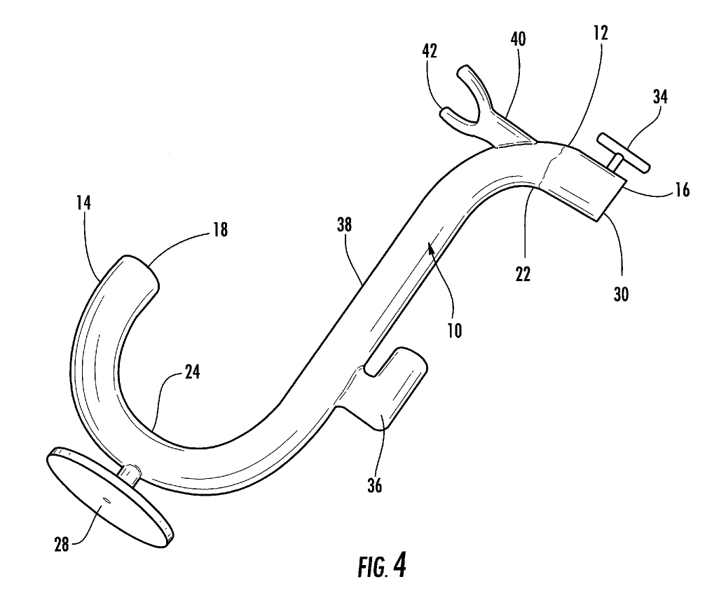

Referring to FIGS. 4-5, the gooseneck tip 10 is generally constructed and arranged to cooperate with a bazooka type automatic tape applicator and includes an upper end portion 12, a lower end portion 14, and a central portion 38. The gooseneck tip 10 has a tubular cross-section along its entire length to transfer drywall compound from the pump to the bazooka. The upper end portion 12 includes the second portion of the quick connector 16. The second portion of the quick connector 16 is constructed and arranged to circumscribe the tube portion 86 of the base member 70. The second portion of the quick connector 16 preferably has a bore 30 that is slightly larger than the tube portion of the base member 70 so that an inner bore of the second portion of the quick connector cooperates with the O-ring 80 positioned along the tube 86 to create a sealed connection. A manually-operable thumbscrew 34 is positioned on the second portion of the quick connector 16 to contact the outer diameter of the tube portion 86. In this manner, when thumbscrew 34 makes contact with the outer diameter of the tube portion 86, the frictional relationship allows the gooseneck tip 10 and mud pump 2 to maintain a seal. A lock indention 90 is sized to accept the distal end of the thumbscrew 34 to provide alignment and additional engagement between the two. It should be noted that while a thumbscrew is disclosed, other types of quick connectors suitable to create engagement between the base member and the tips may be utilized without departing from the scope of the invention. Such quick connectors may include, but should not be limited to ball locks, spring pins, collets and the like. The upper end portion 12 of the gooseneck tip has a substantially 90-degree bend 22. The upper end portion 12 may also include a support plate 40. The support plate is disposed on the substantially 90-degree bend 22, opposite the second portion of the quick connector 16; however, the support plate may be located anywhere along the gooseneck tip 10. The support plate 40 includes a rod member 42 bent into a semi-circular shape that is constructed and arranged to support a bazooka type tape applicator when the joint tape applicator is installed on the outlet 18 of the gooseneck tip 10. The lower end portion 14 contains a substantially 180-degree bend 24 terminating in an outlet 18. The outlet 18 is upwardly facing so as to connect to a bazooka type tape applicator (not shown). On the 180-degree bend 24, a base plate 28 is mounted for support of the gooseneck tip 10. The base plate 28 is sized and shaped to allow a user to step thereon while the gooseneck tip 10 and mud pump 2 are in use to maintain stability without the further use of hands. Between the upper end portion 12 and lower end portion 14 is a central portion 38. The central portion 38 includes an L-shaped tip holder 36. The L-shaped tip holder 36 is sized to fit within the inner bore of an additional tip member to retain the additional tip member with the gooseneck tip, shown in FIG. 5. A tether 92, in the form of a chain, cable or the like, may also be utilized to keep the tips in close proximity to the base member 70. In this manner, a user can quickly change between tips as needed to complete a drywall job. In a preferred embodiment, the tubular cross section is round; however, any tubular shape suitable for cooperation with a bazooka automatic tape machine may be utilized without departing from the scope of the invention. The gooseneck tip is preferably constructed of aluminum; however, any metal or plastic suitable for transfer of drywall compound could be utilized without departing from the scope of the invention.

As shown in FIGS. 5-7, the finishing box tip 50 is illustrated. The finishing box tip 50 includes a first end 52 and a second end 54. The first end 52 includes a pair of diverging open ended nozzles 56. Each nozzle 56 includes a nozzle tip 64. The nozzle tips 64 are sized to fit within a finishing flat box (not shown) for filling it with joint compound. The second end 54 of the finishing box tip 50 comprises another second portion of the quick connector 16 and is constructed and arranged to circumscribe the tube portion 86 of the base member 70, similar to the gooseneck connection. The second portion of the quick connector 16 preferably has a bore 30 that is slightly larger than the tube portion of the base member 70, so that an inner bore of the second portion of the quick connector cooperates with the O-ring 80 positioned along the tube 86 to create a sealed connection. In use, the gooseneck is detached from the tube portion on the base member and the finish box tip is attached for facilitate in filling of a flat box, not shown. More specifically, the second end 54 of the finishing box tip 50 is attached to the tube portion 86 on the base member 70. Not shown, it is contemplated that a manually-operable thumbscrew may be positioned on the second portion of the quick connector of the finishing box tip to contact the outer diameter of the tube portion. In this manner, when the thumbscrew makes contact with the outer diameter of the tube portion, the frictional relationship allows the finishing box tip 50 and mud pump 2 to maintain a seal. It should be noted that while a thumbscrew is contemplated, other types of quick connectors suitable to create engagement between the base member and the tips may be utilized without departing from the scope of the invention. Such quick connectors may include, but should not be limited to ball locks, spring pins, collets and the like.

As shown in FIG. 7, an alternative seal between the discharge port of the mud pump and the connection flange is contemplated. The rear surface 76 of the connection flange 72 may be provided with an O-ring groove 78 and O-ring 80. This construction minimizes the amount of drywall compound that can seep between the flanges 13, 72 during operation of the pump.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A system for dispensing drywall joint compound from a container comprising of:
a base member, being removably securable to a manual joint compound pump, said base member including an outwardly extending first portion of a quick connector; and
a gooseneck tip having an upper end portion, a central portion, and lower end portion, said central portion having an L-shaped tip holder, said upper end portion having a substantially 90-degree bend terminating in a second portion of said quick connector, and said lower end portion having a substantially 180-degree bend terminating in a vertically-oriented outlet;
whereby said first portion is constructed and arranged to cooperate in a telescoping manner with a second portion of said quick connector.

2. The system for dispensing drywall joint compound of claim 1, wherein said first portion is comprised of a tube portion and said second portion is constructed and arranged to circumscribe said tube portion in a telescoping manner.

3. The system for dispensing drywall joint compound of claim 2, wherein said second portion includes a bore having a cross-section larger than an outer diameter of said tube portion, said bore including a manually-operable thumbscrew positioned for frictional engagement with said outer diameter of said tube portion.

4. The system for dispensing drywall joint compound of claim 3, wherein said first portion and second portion of said quick connector are in fluid communication.

5. The system for dispensing drywall joint compound of claim 3, wherein said tube portion has a lock indentation sized to accept a distal end of said thumbscrew to provide alignment and additional engagement.

6. The system for dispensing drywall joint compound of claim 1, wherein said gooseneck tip has a tubular cross-section along a length of said gooseneck tip.

7. The system for dispensing drywall joint compound of claim 1, wherein said base member includes a pair of apertures, said apertures sized and shaped to cooperate with a discharge port of a manual joint pump.

8. The system for dispensing drywall joint compound of claim 1, wherein said gooseneck upper end portion includes a support plate disposed on said 90-degree bend opposite said second portion of said quick connector, said support plate having a semi-circular shaped rod constructed and arranged to support a bazooka type tape applicator.

9. The system for dispensing drywall joint compound of claim 1, wherein said gooseneck lower end includes a base plate disposed on said 180-degree bend, said base plate sized and shaped to allow a user to step on said base plate when said gooseneck tip is in use to maintain stability.

10. The system for dispensing drywall joint compound of claim 1, wherein said L-shaped tip holder is sized to fit within a finishing tip member.

11. The system for dispensing drywall joint compound of claim 10, wherein said finishing tip member is comprised of a first end and second end, said first end includes a pair of diverging open-ended nozzles, said second end includes a finishing tip bore constructed and arranged to circumscribe said tube portion of said base member.

12. The system for dispensing drywall joint compound of claim 11, wherein said nozzles are sized to fit within a finishing flat box.
